(19) United States
(12) Patent Application Publication
(10) Pub. No.: US 2024/0291203 A1
(43) Pub. Date: Aug. 29, 2024

(54) MOUNTING ASSEMBLY FOR AN ELECTRICAL CONNECTOR

(71) Applicants: TE CONNECTIVITY BRASIL INDUSTRIA DE ELECTRONICOS LTDA, Braganca Paulista (BR); TE Connectivity Solutions GmbH, Schaffhausen (CH)

(72) Inventors: Natanael Marcondes dos Santos, Braganca Paulista (BR); Dinesh Loku Hemnani, Winston Salem, NC (US); Michael Dale Brown, Winston Salem, NC (US); David James Rhein, Troy, MI (US); Rafael Kazuo Sato T. Leme, Braganca Paulista (BR); Gustavo Bonucci, Braganca Paulista (BR)

(21) Appl. No.: 18/441,211

(22) Filed: Feb. 14, 2024

Related U.S. Application Data
(60) Provisional application No. 63/447,716, filed on Feb. 23, 2023.

(51) Int. Cl. H01R 13/639; H01R 13/502; H01R 13/629; H01R 13/633

(52) U.S. Cl. CPC H01R 13/639; H01R 13/502; H01R 13/62955; H01R 13/6335

(57) ABSTRACT

An electrical connector includes a housing extending between a mating end and a mounting end configured to be mounted to a panel. A base of the housing is received in an opening in the panel and a flange of the housing is mounted to a first side of the panel. The electrical connector includes a contact assembly received in a cavity of the housing having a contact. The electrical connector includes a securing element extending from the housing located at a second side of the panel. The electrical connector includes a locking mechanism coupled to the securing element having a slide configured to interface with the second side of the panel to secure the housing to the panel and move in a sliding locking direction parallel to the second side from an unlocked position to a locked position. The locking mechanism interfaces with the securing element in the locked position to secure the housing to the panel.

### CROSS REFERENCE TO RELATED APPLICATIONS

This application claims benefit to U.S. Provisional Application No. 63/447,716, filed 23 Feb. 2023, titled “HEADER LOCKING MECHANISM”, the subject matter of which is herein incorporated by reference in its entirety.

### BACKGROUND OF THE INVENTION

The subject matter herein relates generally to electrical connectors.

Connector systems use electrical connectors to interconnect various components. Some connector systems transmit power and or data from one component to another component. For instance, power connectors may be used to connect a power source, such as a battery, to a load, such as a motor. For example, in an electric vehicle, the battery may be connected to the invertor or electric motor through a plug connector and a header connector. The header connector is mounted to one of the components, such as the motor, and the plug connector is provided at an end of a cable harness routed between the battery and the plug connector. Connection of the header connector to the component involves bolting a mounting flange of the header connector to a panel or other structure of the component. For example, four bolts may be used in four corners of the mounting flange. Bolted connections require assembly time and hardware, such as nuts and bolts, to make the connection between the header connector and the structure.

A need remains for a connector system having a boltless and reliable connection between the electrical connector and the structure.

### BRIEF DESCRIPTION OF THE INVENTION

In one embodiment, an electrical connector is provided and includes a housing extending between a mating end and a mounting end. The mating end is configured to be mated with a mating electrical connector. The mounting end is configured to be mounted to a panel. The mounting end includes a base and a flange extending from the base. The base of the housing is received in an opening in the panel. The flange of the housing is mounted to a first side of the panel. The housing has a cavity. The electrical connector includes a contact assembly received in the cavity of the housing. The contact assembly includes at least one contact configured to be mated to the mating electrical connector. The electrical connector includes a securing element extending from the housing and located at a second side of the panel. The electrical connector includes a locking mechanism coupled to the securing element. The locking mechanism includes a slide configured to interface with the second side of the panel to secure the housing to the panel and move in a sliding locking direction parallel to the second side from an unlocked position to a locked position. The locking mechanism interfaces with the securing element in the locked position to secure the housing to the panel.

In another embodiment, an electrical connector is provided and includes a housing extending between a mating end and a mounting end. The mating end is configured to be mated with a mating electrical connector. The mounting end is configured to be mounted to a panel. The mounting end includes a base and a flange extending from the base. The base of the housing is received in an opening in the panel. The flange of the housing is mounted to a first side of the panel. The housing has a cavity. The housing includes a housing locking element. The electrical connector includes a contact assembly received in the cavity of the housing. The contact assembly includes at least one contact configured to be mated to the mating electrical connector. The electrical connector includes a securing element extending from the housing and located at a second side of the panel. The electrical connector includes a locking mechanism coupled to the securing element. The locking mechanism includes a slide configured to interface with the second side of the panel to secure the housing to the panel and move in a sliding locking direction parallel to the second side from an unlocked position to a locked position. The locking mechanism interfaces with the securing element in the locked position to secure the housing to the panel. The locking mechanism includes a header position assurance device coupled to the slide. The header position assurance device configured to be lockingly secured to the housing locking element only when the locking mechanism is in the locked position.

In a further embodiment, an electrical connector is provided and includes a housing extending between a mating end and a mounting end. The mating end is configured to be mated with a mating electrical connector. The mounting end is configured to be mounted to a panel. The mounting end includes a base and a flange extending from the base. The flange of the housing is mounted to a first side of the panel. The base of the housing is received in an opening in the panel. The base includes a locking leg has a housing locking tab. The locking leg is located at a second side of the panel. The housing has a cavity. The electrical connector includes a contact assembly received in the cavity of the housing. The contact assembly includes at least one contact configured to be mated to the mating electrical connector. The electrical connector includes a securing element extending from the housing and located at a second side of the panel. The electrical connector includes a locking mechanism coupled to the securing element. The locking mechanism includes a slide configured to interface with the second side of the panel to secure the housing to the panel and move in a sliding locking direction parallel to the second side from an unlocked position to a locked position. The locking mechanism interfaces with the securing element in the locked position to secure the housing to the panel. The locking mechanism includes a slide locking tab extending from the slide. The slide locking tab engages the housing locking tab when the slide is in the locked position to prevent lift off of the flange of the housing from the panel.

### BRIEF DESCRIPTION OF THE DRAWINGS

FIG. 1 is a perspective view of an electrical connector system utilizing mounting features in accordance with an exemplary embodiment.

FIG. 2 is a top perspective view of a portion of the electrical connector system showing the header connector poised for coupling to the panel in accordance with an exemplary embodiment.

FIG. 3 is a bottom perspective view of a portion of the electrical connector system showing the header connector in accordance with an exemplary embodiment mounted to the panel.

FIG. 4 is a bottom view of the electrical connector system showing the header connector initially mounted to the panel in accordance with an exemplary embodiment.

FIG. 5 is a bottom perspective view of the electrical connector system showing the header connector secured to the panel in accordance with an exemplary embodiment.

FIG. 6 is a cross sectional view of the electrical connector system showing the header connector mounted to the panel in accordance with an exemplary embodiment.

FIG. 7 is a cross sectional view of the electrical connector system showing the header connector mounted to the panel in accordance with an exemplary embodiment.

FIG. 8 is a bottom perspective view of a portion of the header connector showing the locking mechanism securing the header housing to the panel in accordance with an exemplary embodiment.

FIG. 9 is a bottom view of a portion of the header connector showing the locking mechanism in an unlocked position in accordance with an exemplary embodiment.

FIG. 10 is a bottom view of a portion of the header connector showing the locking mechanism in a locked position in accordance with an exemplary embodiment.

### DETAILED DESCRIPTION OF THE INVENTION

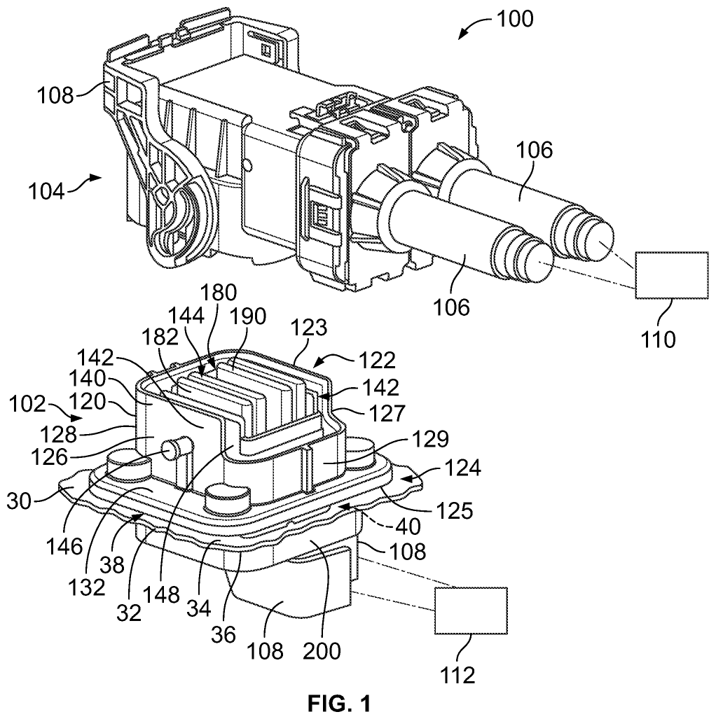

FIG. 1 is a perspective view of an electrical connector system 100 utilizing mounting features in accordance with an exemplary embodiment. In an exemplary embodiment, the mounting features include a slidable locking mechanism 200 configured secure components together, such as by a sliding and wedge securing action. The electrical connector system 100 is an exemplary system utilizing the locking mechanism 200 and the subject matter herein is not intended to be limited to use with the illustrated electrical connector system 100.

The electrical connector system 100 includes electrical connectors 102, 104 configured to be mated at a separable mating interface. In an exemplary embodiment, the electrical connectors 102, 104 are a header connector 102 and a plug connector 104, respectively. The plug connector 104 is a mating electrical connector configured to be mated with the header connector 102. The plug connector 104 is shown poised for mating with the header connector 102.

The header connector 102 is mounted to a structure 30 of a component. In an exemplary embodiment, the structure 30 is a panel 32 having a first or upper surface 34 and a second or lower surface 36. The panel 32 has a mounting area 38 and the header connector 102 is configured to be mounted to the panel 32 at the mounting area 38. In an exemplary embodiment, the panel 32 includes an opening 40 at the mounting area 38. The header connector 102 is received in the opening 40 and mounted to the panel 32 at the mounting area 38. In an exemplary embodiment, the panel 32 is conductive. For example, the panel 32 may be manufactured from a metal material, such as steel. The panel 32 may be a piece of sheet metal. In an exemplary embodiment, the panel 32 is a coated structure wherein one or more layers of the panel are coated layers. In an exemplary embodiment, the mounting features of the header connector 102 allow mounting to the panel 32 by a boltless and/or toolless connection. For example, the header connector 102 may be secured using the locking mechanism 200 that secures the header connector 102 to the panel 32 by a sliding wedge-like securing action, without the use of bolts or other fasteners. The panel 32 may be oriented horizontally such that the first surface 34 is an upper surface and the second surface 36 is a lower surface; however, other orientations are possible in alternative embodiments.

In an exemplary embodiment, the electrical connector system 100 is a high power connector system that is used to transfer power between various components as part of a high power circuit. In a particular application, the electrical connector system 100 is a battery system, such as a battery system of a vehicle, such as an electric vehicle or hybrid electric vehicle; however, the electrical connector system 100 is not intended to be limited to such battery systems.

The plug connector 104 is configured to be electrically connected to a component 110, such as through one or more power cables 106. For example, the plug connector 104 may be electrically connected to a battery, a charger, an inverter, an electric motor or another type of component. The header connector 102 is configured to be electrically connected to a component 112, such as through a power bus; however the header connector 102 may be electrically connected to the component 112 by other means, such as a terminal, power wire or other connector. For example, the header connector 102 may be electrically connected to a battery pack, such as through a battery distribution unit, a manual service disconnect, a charger, an inverter, an electric motor, or another type of component. The battery distribution unit may manage the power capacity and functionality of the electrical connector system 100, such as by measuring current and regulating power distribution of the battery pack.

In the illustrated embodiment, the electrical connector system 100 is a right angle connector system where the connectors 102, 104 are mated in a direction perpendicular to the power wires 106. However, the power wires 106 may extend from the plug connector 104 in a direction parallel to the mating direction in alternative embodiments. In various embodiments, the mating direction is a vertical mating direction. For example, the plug connector 104 is mated to the header connector 102 in a vertically downward direction. Optionally, the plug connector 104 may be removably coupled to the header connector 102 to disconnect the high power circuit of one or more of the components, such as the battery pack, the electric motor, the inverter, or other components of the vehicle, such as for maintenance, repair or for another reason. When mated, one or more header contacts of the header connector 102 are mated with corresponding plug terminals of the plug connector 104, such as at mating interfaces thereof.

The header connector 102 includes a header housing 120 and a contact assembly 180. The header housing 120 holds the contact assembly 180. The contact assembly 180 is configured to be mated with the plug connector 104 to make an electrical connection with the plug connector 104. The contact assembly 180 is configured to be electrically connected to the component 112, such as by a busbar, a cable, wires, or other types of electrical connectors.

The header housing 120 has a mating end 122 at a top 123 of the header housing 120 and a mounting end 124 at a bottom 125 of the header housing 120. The header housing 120 includes a base 130 at the mounting end 124 and a shroud 140 extending from the base 130. The shroud 140 is provided at the mating end 122 and surrounds the contact assembly 180. The shroud 140 includes shroud walls 142 surrounding a cavity 144. The cavity 144 receives the contact assembly 180. The shroud walls 142 extend along first and second sides 126, 127 of the header housing 120 and extend along a front 128 and a rear 129 of the header housing 120. As such, the contact assembly 180 is surrounded on all four sides. Optionally, the shroud walls 142 at the rear 129 may be shorter than the shroud walls 142 at the front 128. The shroud walls 142 may include guide features, such as tabs, ribs, or channels extending along the shroud walls 142 to guide mating with the plug connector 104. The shroud 140 is configured to be plugged into the plug connector 104.

In an exemplary embodiment, the shroud 140 includes mounting pins 146 extending from the shroud walls 142. The plug connector 104 is configured to be mounted to the mounting pins 146. For example, a lever 108, which is rotatably coupled to the housing of the plug connector 104, is configured to be coupled to the mounting pins 146.

In an exemplary embodiment, a header shield 148 is coupled to the header housing 120. The header shield 148 may be coupled to the shroud 140 and/or the base 130. The header shield 148 is configured to be electrically connected to the plug connector 104 when the plug connector 104 is coupled to the header connector 102. In an exemplary embodiment, the header shield 148 is configured to be electrically connected to the panel 32 to electrically common the plug connector 104 with the panel 32. The header shield 148 may provide shielding around the contact assembly 180. In an exemplary embodiment, the header shield 148 extends along interior surfaces of the shroud walls 142. Optionally, the header shield 148 may extend from the shroud 140 into the base 130. For example, the header shield 148 may be wrapped around the base 130 to an exterior of the base 130 to electrically connect to the panel 32.

In an exemplary embodiment, the contact assembly 180 includes a contact holder 182 holding one or more header contacts 190. For example, the header contact 190 may be received in contact channels passing through the contact holder 182. The contact holder 182 is manufactured from a dielectric material to isolate the header contact 190 from each other and from the header shield 148. In the illustrated embodiment, the contact holder 182 is separate and discrete from the header housing 120. However, in alternative embodiments, the contact holder 182 may be integral with the header housing 120 such as being co-molded with the header housing 120. For example, the header housing 120 may be molded with contact channels in the base 130 that receive the header contact 190. In such embodiments, the header housing 120 directly holds the contacts 190.

The base 130 holds the contact assembly 180. For example, the contact assembly 180 may be plugged into the base 130. The base 130 may include an opening or channels that receive portions of the contact assembly 180. The base 130 is configured to be mounted to the panel 32. Optionally, the base 130 may extend through the opening 134 such that the base 130 is located both above the upper surface 34 and below the lower surface 36 of the panel 32. In an exemplary embodiment, the base 130 includes a flange 132 extending outward from the base 130. The base 130 is configured to be plugged through the opening 40 in the panel 32. The flange 132 is configured be mounted to the panel 32 at the mounting area 38. For example, the flange 132 faces the upper surface 34 of the panel 32. In an exemplary embodiment, the flange 132 abuts against a mounting surface at the upper surface 34 of the mounting area 38. The locking mechanism 200 may be used to press the flange 132 against the mounting surface of the panel 32. For example, the wedge action of connecting the locking mechanism 200 to the header housing 120 causes the flange 132 to press downward toward the upper surface 34 of the panel 32. In an exemplary embodiment, a sealed interface is defined between the header connector 102 and the panel 32, such as at the bottom surface of the flange 132 and the upper surface 34 of the panel 32. The seal at the sealed interface may be compressed between the panel 32 and the flange 132.

In an exemplary embodiment, the locking mechanism 200 of the header connector 102 is used to mount the flange 132 to the mounting area 38 at the upper surface 34. For example, the locking mechanism 200 may secure the flange 132 to the upper surface 34 of the panel 32. In an exemplary embodiment, the locking mechanism 200 interfaces with the lower surface 36 of the panel 32 to press the flange 132 into the upper surface 34 of the panel 32 to rigidly secure the header connector 102 to the panel 32. The panel 32 is sandwiched between the locking mechanism 200 and the flange 132. In an exemplary embodiment, the locking mechanism 200 is slidably coupled to the header housing 120. For example, the locking mechanism 200 may be moved in a sliding locking direction parallel to the panel 32 from an unlocked position to a locked position to secure the header connector 102 to the panel 32. In an exemplary embodiment, the sliding of the locking mechanism 200 tightens the header housing 120 to the panel 32, such as using a wedge-like sliding action. When assembled, the flange 132 is pressed downward toward the panel 32 into engagement with the panel 32 to create a tight connection between the header housing 120 and the panel 32. Actuation of the locking mechanism 200 presses the flange 132 downward to compress the seal between the flange 132 and the upper surface 34 of the panel 32. In an exemplary embodiment, the locking mechanism 200 may be locked or otherwise secured in the locked position to prevent inadvertent unlocking or disassembly of the header connector 102 from the panel 32. The locking mechanism 200 secures the header connector 102 to the panel 32 without the use of fasteners or bolt. The mounting action may be performed manually, by hand or by an assembly machine. A boltless connection is provided by the locking mechanism 200.

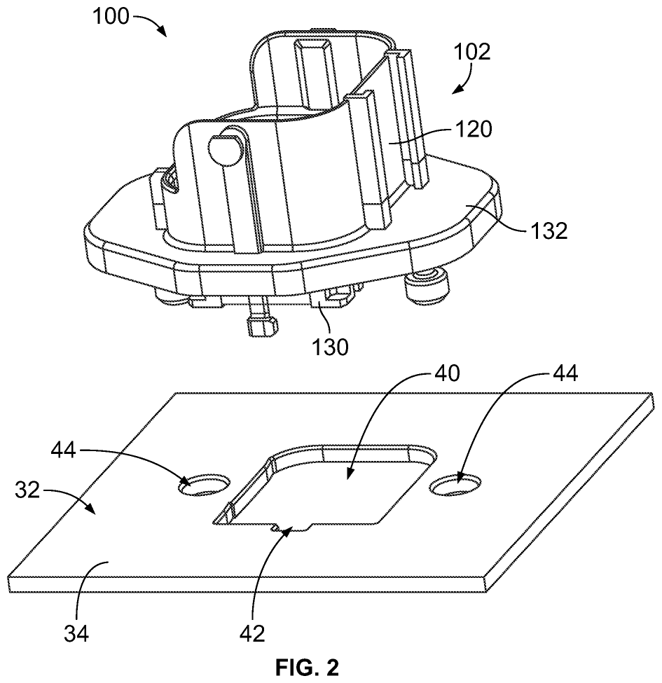

FIG. 2 is a top perspective view of a portion of the electrical connector system 100 showing the header connector 102 poised for coupling to the panel 32. The panel 32 includes the opening 40. The opening 40 passes through the panel 32. The opening 40 is shaped to receive the header connector 102, such as the base 130 at the bottom of the header connector 102. In an exemplary embodiment, the opening 40 includes a notch 42 at one of the sides. The notch 42 receives a portion of the header connector 102. In an exemplary embodiment, the panel 32 includes one or more secondary openings 44 adjacent the opening. For example, in the illustrated embodiment, the panel 32 includes a pair of the secondary openings 44 at opposite sides of the opening 40. The openings 44 are small openings to receive portions of the header connector 102 used for securing the header connector 102 to the panel 32.

During assembly, the header housing 120 is loaded into the opening 40 in the panel 32 from above. The flange 132 is located above the upper surface 34 of the panel 32. In an exemplary embodiment, a seal (not shown) is located between the flange 132 and the upper surface 34 of the panel 32. During initial assembly, the seal is not compressed. However, after mounting and assembly of the locking mechanism 200 (FIG. 1) to the header housing 120, the seal is compressed between the flange 132 and the panel 32. For example, the flange 132 is pulled downward into engagement with the upper surface 34 of the panel 32. During assembly, securing features of the header connector 102 are aligned with and configured to be loaded into the secondary openings 44.

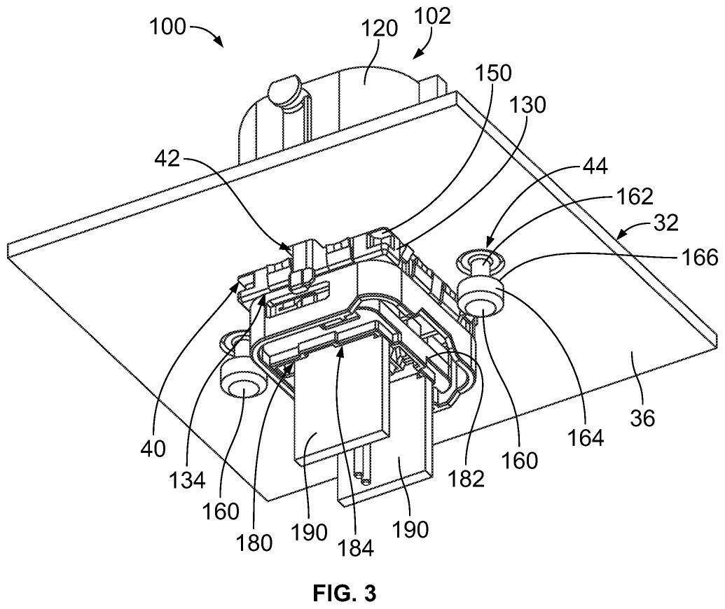

FIG. 3 is a bottom perspective view of a portion of the electrical connector system 100 showing the header connector 102 in accordance with an exemplary embodiment mounted to the panel 32. The contact assembly 180 is shown coupled to the header housing 120 in FIG. 3. For example, the contact holder 182 is received in an opening 134 in the base 130. The contact holder 182 holds the header contacts 190. In the illustrated embodiment, the contact assembly 180 includes a pair of the header contacts 190. Greater or fewer header contacts 190 may be provided in alternative embodiments. In the illustrated embodiment, the header contacts 190 are blade contacts. For example, the header contacts 190 are generally planar plates located in contact channels 184 of the contact holder 182. The header contacts 190 may be busbars configured to be electrically connected to other components. Other types of contacts may be used in alternative embodiments, such as pin contacts, socket contacts, tuning fork contacts, spring beam contacts, or other types of contacts.

In an exemplary embodiment, the header housing 120 includes pre-stage latches 150 used to initially secure the header housing 120 in a pre-stage position on the panel 32. The pre-stage latches 150 are configured to be latchably coupled to the panel 32. In an exemplary embodiment, the pre-stage latches 150 extend from the base 130. The pre-stage latches 150 are received in the opening 40 of the panel 32 and are configured to be latchably coupled to the lower surface 36. The pre-stage latches 150 hold the header housing 120 on the panel 32 at the pre-stage position until the locking mechanism 200 (FIG. 1) can be attached to the header housing 120 to create a more robust and permanent attachment to the panel 32.

In an exemplary embodiment, the header connector 102 includes one or more securing elements 160 extending from the bottom of the header housing 120. The securing elements 160 are configured to interface with the locking mechanism 200 to secure the header connector 102 to the panel 32. In the illustrated embodiment, two of the securing elements 160 are provided on opposite sides of the header housing 120. However, greater or fewer securing elements 160 may be provided in alterative embodiments. In an exemplary embodiment, the securing elements 160 are posts extending from the bottom of the header housing 120. The securing elements 160 may be separate and discrete from the header housing 120 and coupled thereto. In alternative embodiments, the securing elements 160 are integral with the header housing 120, such as being co-molded with the header housing 120.

In an exemplary embodiment, each securing element 160 includes a post 162 and a head 164 at a distal end of the post 162. The post 162 and/or the head 164 may be cylindrical. However, the post 162 and/or the head 164 may have other shapes in alternative embodiments. In an exemplary embodiment, the head 164 is enlarged compared to the post 162. For example, the head 164 may have a larger diameter than the post 162. The head 164 includes an engagement portion 166 extending outward from the post 162. The engagement portion 166 is configured to engage the locking mechanism 200 to secure the locking mechanism 200 to the securing element 160. The engagement portion 166 extends along the enlarged portion of the head 164.

During assembly, the header connector 102 is assembled to the panel 32 such that the securing elements 160 pass through the secondary openings 44. The head 164 is located beyond (for example, below) the second side 36 of the panel 32. The head 164 is spaced apart from the second side 36. The locking mechanism 200 is configured to be received in the gap between the engagement portion 166 of the head 164 and the second side 36 of the panel 32. For example, the locking mechanism 200 may press outward (for example, downward or away from the panel 32) against the head 164 to compress the header housing 120 against the panel 32, such as to compress the seal and rigidly hold the header connector 102 against the panel 32.

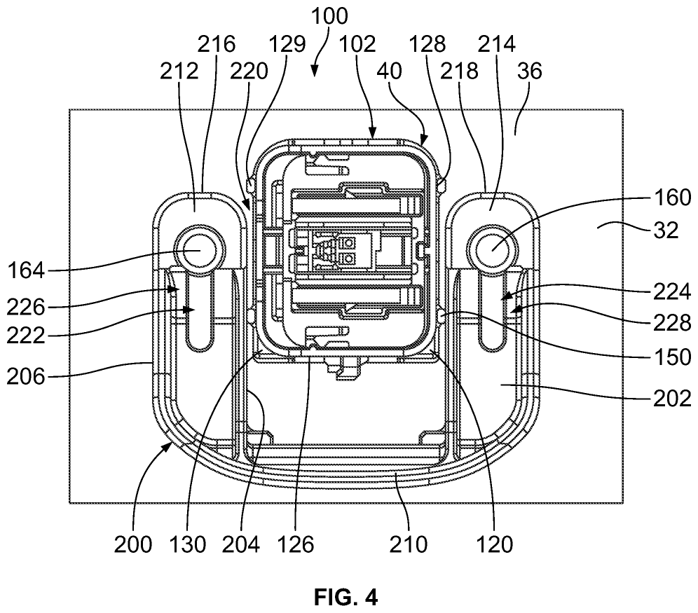

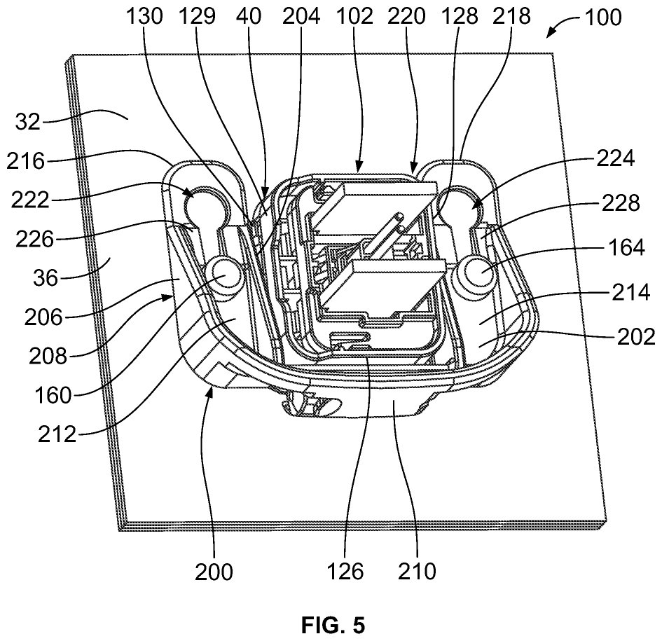

FIG. 4 is a bottom view of the electrical connector system 100 showing the header connector 102 initially mounted to the panel 32. FIG. 5 is a bottom perspective view of the electrical connector system 100 showing the header connector 102 secured to the panel 32. FIG. 4 shows the locking mechanism 200 in an unlocked position. FIG. 5 shows the locking mechanism 200 in a locked position. The locking mechanism 200 is configured to move in a sliding locking direction, parallel to the panel 32, between the unlocked position and the locked position. The locking mechanism 200 engages the securing elements 160 in the locked position to secure the header connector 102 to the panel 32.

The header connector 102 is shown in a pre-stage position in FIG. 4. In the pre-stage position, the header housing 120 is initially positioned relative to the panel 32, such as in the opening 40. The header housing 120 is configured to receive the locking mechanism 200 in the pre-stage position. The header housing 120 is not fully secured to the panel 32 in the pre-stage position. The pre-stage latches 150 are used to initially secure the header housing 120 in the pre-stage position on the panel 32. The pre-stage latches 150 are received in the opening 40 of the panel 32 and are latchably coupled to the lower surface 36. The pre-stage latches 150 hold the header housing 120 on the panel 32 at the pre-stage position until the locking mechanism 200 can be attached to the header housing 120 to create a more robust and permanent attachment to the panel 32.

In an exemplary embodiment, the locking mechanism 200 is separate and discrete from the header housing 120. The locking mechanism 200 is configured to be coupled to the header housing 120, such as to the securing elements 160 at the opposite sides of the header housing 120. Optionally, the locking mechanism 200 may be removably coupled to the header housing 120. For example, the locking mechanism 200 may be separably coupled to the header housing 120 and is removable by pulling the locking mechanism 200 straight off of the securing elements 160 when in the unlocked position. Alternatively, the locking mechanism 200 may be slid off of the securing elements 160, such as in a direction opposite to the sliding locking direction (for example, a sliding unlocking direction).

The locking mechanism 200 includes a slide 202 having an inner end 204 facing the panel 32 and an outer end 206 facing away from the panel 32. The inner end 204 may be a top of the slide 202 and the outer end 206 may be a bottom of the slide 202. The inner end 204 includes a slide interface 208 configured to engage the panel 32. The slide interface 208 may be planar. The slide interface 208 faces the second side 36 of the panel 32. The slide interface 208 is configured to slide along the panel 32 when the locking mechanism 200 is moved between the unlocked position and the locked position.

In an exemplary embodiment, the slide 202 is U-shaped having a handle 210, a first slide arm 212 at a first side of the slide 202 and a second slide arm 214 at a second side of the slide 202. The first slide arm 212 extends to a distal end 216. The second slide arm 214 extends to a distal end 218. A slide pocket 220 is located between the first slide arm 212 and the second slide arm 214. The slide pocket 220 receives the base 130 of the header housing 120. The first slide arm 212 extends along a side of the header housing 120, such as the front 128 or the rear 129 or one of the sides 126, 127. The second slide arm 214 extends along an opposite side of the header housing 120, such as the front 128 or the rear 129 or one of the sides 126, 127. In the locked position, the handle 210 extends along one of the sides of the header housing 120, such as one of the sides 126, 127 or the front 128 or the rear 129. The locking mechanism 200 is movable relative to the header housing 120 by pushing the handle 210 in the sliding locking direction. In an exemplary embodiment, the locking mechanism 200 is slidable, such as in a horizontal sliding direction, relative to the header housing 120, such as to move the locking mechanism 200 between the unlocked position and the locked position. The handle 210 is located adjacent the rear 129 in the locked position and is configured to be spaced apart from the rear 129 in the unlocked position.

In an exemplary embodiment, the first slide arm 212 includes an opening 222 configured to receive the corresponding securing element 160. The opening 222 may be enclosed or completely surrounded by the first slide arm 212. In alternative embodiments, the opening 222 may be open sided, such as being open at the distal end 216 or at a side of the first slide arm 212. In the illustrated embodiment, the opening 222 is keyhole shaped having a wide portion and a narrow portion. The wide portion is located proximate to the distal end 216 and the narrow portion extends from the wide portion in a direction away from the distal end 216. The securing element 160 is configured to be loaded into and removed from the opening 222 through the wide portion and is unable to be removed from the opening 222 through the narrow portion. The first slide arm 212 slides relative to the securing element 160 to move the securing element 160 between the wide portion and the narrow portion.

In an exemplary embodiment, the second slide arm 214 includes an opening 224 configured to receive the corresponding securing element 160. The opening 224 may be enclosed or completely surrounded by the second slide arm 214. In alternative embodiments, the opening 224 may be open sided, such as being open at the distal end 218 or at a side of the second slide arm 214. In the illustrated embodiment, the opening 224 is keyhole shaped having a wide portion and a narrow portion. The wide portion is located proximate to the distal end 218 and the narrow portion extends from the wide portion in a direction away from the distal end 218. The securing element 160 is configured to be loaded into and removed from the opening 224 through the wide portion and is unable to be removed from the opening 224 through the narrow portion. The second slide arm 214 slides relative to the securing element 160 to move the securing element 160 between the wide portion and the narrow portion.

In an exemplary embodiment, the first slide arm 212 includes a ramp 226 at the outer end 206. The ramp 226 changes a thickness of the first slide arm 212, such as from a thin portion to a thick portion. The ramp 226 is angled between the thin portion and the thick portion. The ramp 226 is located along the opening 222. For example, the thin portion is located along the wide portion of the opening 222 and the ramp 226 and the thick portion are located along the narrow portion of the opening 222. The head 164 of the securing element 160 is configured to engage the first slide arm 212 along the ramp 226 and the thick portion to pull the header housing 120 against the panel 32, such as to press the flange 132 against the first surface 34 of the panel 32, such as to compress the seal between the flange 132 and the panel 32.

In an exemplary embodiment, the second slide arm 214 includes a ramp 228 at the outer end 206. The ramp 228 changes a thickness of the second slide arm 214, such as from a thin portion to a thick portion. The ramp 228 is angled between the thin portion and the thick portion. The ramp 228 is located along the opening 224. For example, the thin portion is located along the wide portion of the opening 224 and the ramp 228 and the thick portion are located along the narrow portion of the opening 224. The head 164 of the securing element 160 is configured to engage the second slide arm 214 along the ramp 228 and the thick portion to pull the header housing 120 against the panel 32, such as to press the flange 132 against the second surface 34 of the panel 32, such as to compress the seal between the flange 132 and the panel 32.

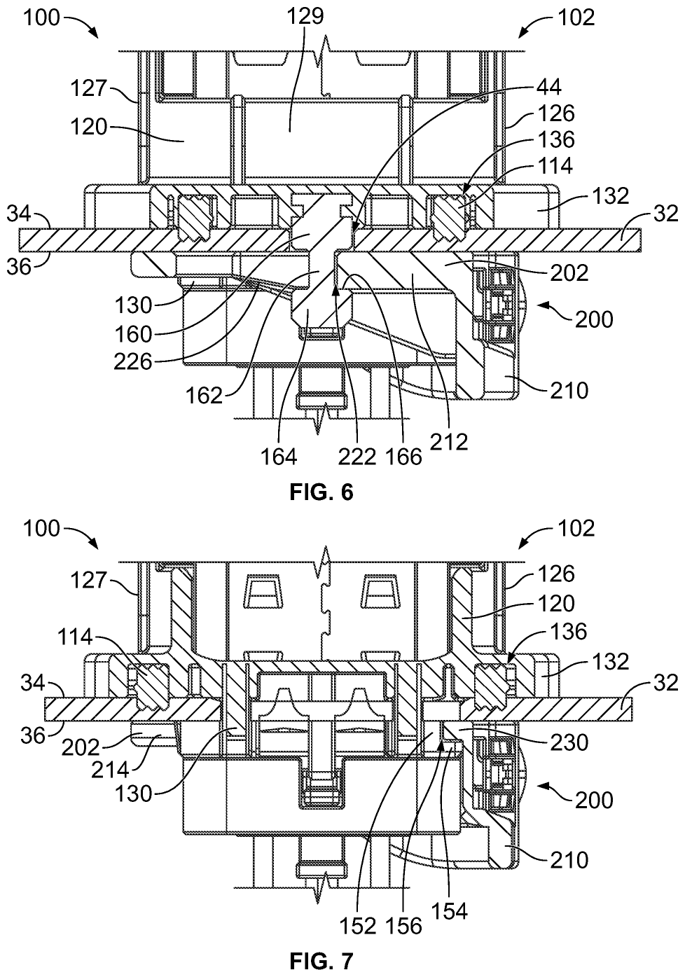

FIG. 6 is a cross sectional view of the electrical connector system 100 showing the header connector 102 mounted to the panel 32. FIG. 7 is a cross sectional view of the electrical connector system 100 showing the header connector 102 mounted to the panel 32.

In an exemplary embodiment, the flange 132 includes a seal pocket 136 that receives a seal 114. In an exemplary embodiment, the seal 114 completely surrounds the base 130. For example, the seal 114 is continuous along both sides 126, 127, the front 128, and the rear 129. The seal 114 is configured to be sealingly coupled to the header housing 120 and is configured to be sealingly coupled to the panel 32. In various embodiments, the seal 114 may be a rubber gasket. In an exemplary embodiment, the seal 114 is compressible. Compression of the seal 114 creates a tight seal to the header housing 120 and the panel 32. In an exemplary embodiment, the locking mechanism 200 is used to compress the seal 114 when the locking mechanism 200 is coupled to the header housing 120.

In an exemplary embodiment, the header housing 120 includes the securing elements 160 extending outward from the base 130. The securing elements 160 pass through the secondary openings 44 in the panel 32 such that the head 164 is located below the lower surface 36 of the panel 32. The locking mechanism 200 is configured to be coupled to the securing elements 160. The locking mechanism 200 may be slidably coupled to the securing elements 160 in the sliding locking direction. The slide arm 212 engages the corresponding securing element 160. The opening 222 guides the movement of the slide arm 212 along the securing element 160. As the locking mechanism 200 is moved to the locked position, the slide arm 212 is received in the space between the engagement portion 166 of the head 164 and the second side 36 of the panel 32. For example, the ramp 226 engages the head 164 and forces the head 164, and thus the header housing 120 outward (for example, downward or away from the panel 32). The header housing 120 is moved downward toward the panel 32, such as to compress the seal 114 and rigidly hold the header connector 102 against the panel 32.

In an exemplary embodiment, the base 130 of the header housing 120 includes a locking leg 152 (FIG. 7) at the bottom of the base 130. The locking leg 152 includes a housing locking tab 154 extending form the locking leg 152. The locking leg 152 and the housing locking tab 154 form a pocket 156. The pocket 156 is configured to receive a portion of the locking mechanism 200. During assembly, when the base 130 is loaded through the opening 40, the locking leg 152 is located at the second side of the panel 32, such as below the panel 32. In the illustrated embodiment, the locking leg 152 is located at one of the sides 126, 127. Other locations are possible in alternative embodiments, such as along the front 128 or the rear 129 of the header housing 120.

In an exemplary embodiment, the locking mechanism 200 includes a slide locking tab 230 (FIG. 7) extending from the slide 202. The slide locking tab 230 may be located at the handle 210. However, the slide locking tab 230 may be located at the first slide arm 212 and/or the second slide arm 214. In an exemplary embodiment, the slide locking tab 230 engages the housing locking tab 154 when the slide 202 is in the locked position. For example, the slide locking tab 230 may be received in the pocket 156 when the locking mechanism 200 is in the locked position. The slide locking tab 230 holds the header housing 120 relative to the locking mechanism 200 and the panel 32. For example, the slide locking tab 230 prevents vertical (for example upward) movement of the header housing 120 relative to the locking mechanism 200. The slide locking tab 230 prevents liftoff of the flange 132 from the first side 34 of the panel 32. For example, the slide locking tab 230 is located between the second side 36 of the panel 32 and the housing locking tab 154. The slide locking tab 230 prevents movement of the housing locking tab 154 toward the second side 36 of the panel 32, thus preventing liftoff of the flange 132 from the first side 34 of the panel 32. The slide locking tab 230 provides an additional securing means in addition to the ramps 226 engaging the securing elements 160.

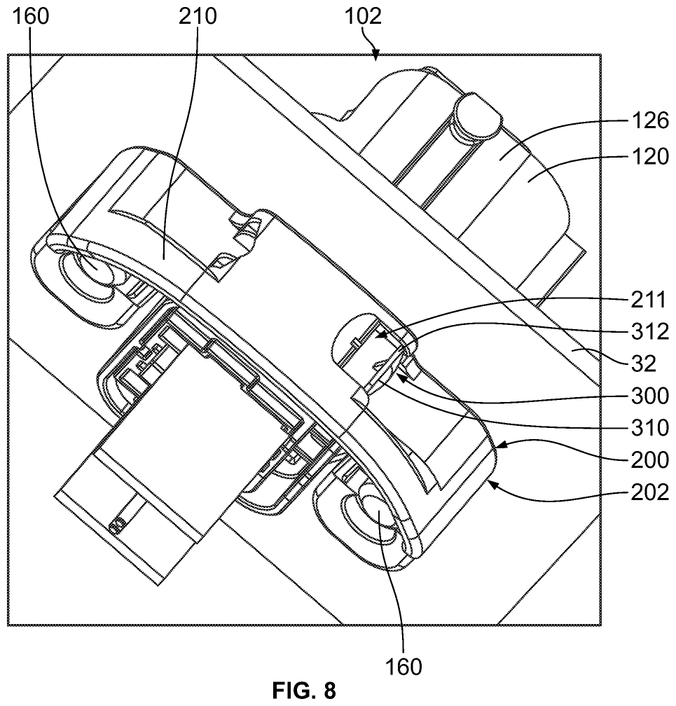

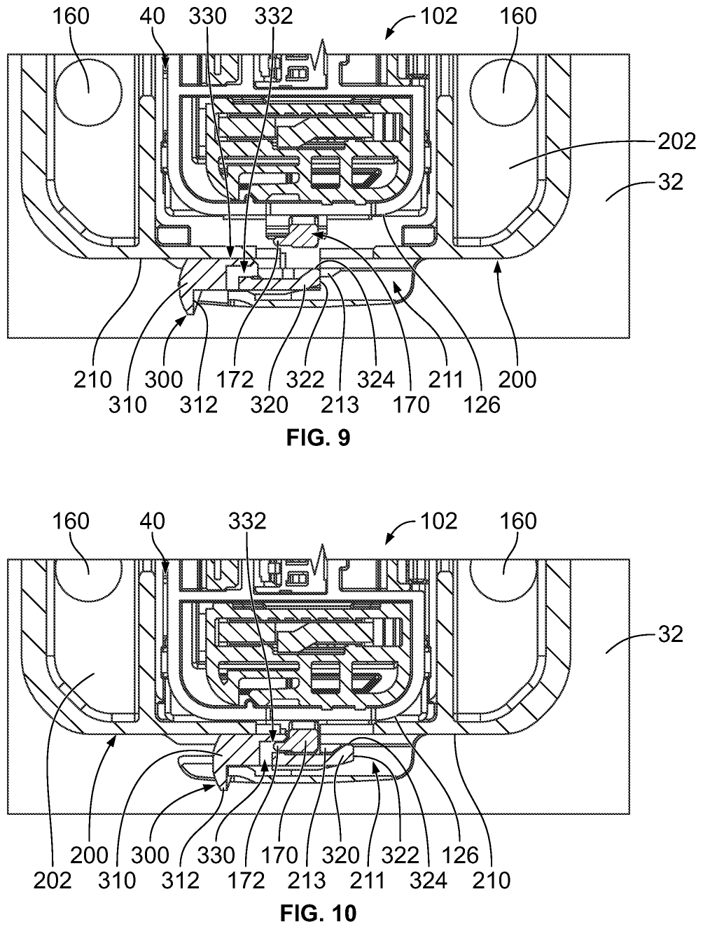

FIG. 8 is a bottom perspective view of a portion of the header connector 102 showing the locking mechanism 200 securing the header housing 120 to the panel 32. FIG. 9 is a bottom view of a portion of the header connector 102 showing the locking mechanism 200 in an unlocked position. FIG. 10 is a bottom view of a portion of the header connector 102 showing the locking mechanism 200 in a locked position. In an exemplary embodiment, the header connector 102 includes a header position assurance device 300 providing a visual and mechanical identifier to the installer to assure that the header connector 102 is in the locked position. In an exemplary embodiment, the header position assurance device 300 is configured to lock the locking mechanism 200 in the locked position. For example, when the header position assurance device 300 is activated, the locking mechanism 200 is fixed into the header housing in the locked position and is unable to move to the unlocked position until the header position assurance device 300 is deactivated.

During assembly, the header housing 120 is initially coupled to the panel 32 by plugging the base 130 through the opening 40. The locking mechanism 200 may then be coupled to the header housing 120 in the sliding locking direction. The locking mechanism 200 securely couples to the securing elements 160 as the locking mechanism 200 is slid to the locked position. The locking mechanism 200 is slid in the locking direction to the locked position by pressing the handle 210 toward the rear 129 of the header housing 120 to lock the locking mechanism 200 relative to the header housing 120. The header housing 120 is moved downward as the locking mechanism 200 is secured to the securing elements 160. For example, the flange 132 is moved toward the panel 32 causing the seal to compress and the header housing 120 to rigidly couple to the panel 32. The header position assurance device 300 is configured to be activated and locked to the header housing 120 when the locking mechanism 200 is in the locked position.

In an exemplary embodiment, the header connector 102 includes a housing locking element 170 (FIG. 9). For example, the housing locking element 170 extends from the header housing 120. In various embodiments, the housing locking element 170 may be integral with the header housing 120, such as being comolded with the header housing 120. Alternatively, the housing locking element 170 may be a separate and discrete component coupled to the header housing 120. The housing locking element 170 is located at the bottom of the header housing 120. In an exemplary embodiment, the housing locking element 170 is configured to pass through the notch 42 (FIG. 2) as the header housing 120 is loaded into the opening 40. The housing locking element 170 is configured to interface with the header position assurance device 300 to lock the locking mechanism 200 to the header housing 120. In an exemplary embodiment, the housing locking element 170 includes a locking finger 172 at a distal end of the housing locking element 170. The locking finger 172 is configured to engage the header position assurance device 300 to lock the locking mechanism 200 to the header housing 120. In an exemplary embodiment, the header position assurance device 300 is configured to be lockingly secured to the housing locking element 170 only when the locking mechanism 200 is in the locked position (FIG. 10).

In an exemplary embodiment, the header position assurance device 300 is coupled to the slide 202. For example, the header position assurance device 300 may be coupled to the handle 210. The header position assurance device 300 may be slidably coupled to the handle 210. For example, the header position assurance device 300 may be received in a pocket 211 in the handle 210. The header position assurance device 300 is movable relative to the handle 210 between an unlocked position (FIG. 9) and a locked position (FIG. 10). The header position assurance device 300 is configured to be lockingly secured to the housing locking element 170 when the header position assurance device 300 is in the locked position.

In an exemplary embodiment, the header position assurance device 300 includes an actuator 310 and a latch 320 extending from the actuator 310. The actuator 310 includes a grip element 312 that may be grabbed or engaged by the installer. For example, the grip element 312 may be grabbed between the installers finger and thumb to slide the actuator 310, such as left and right between the unlocked and locked positions. In an exemplary embodiment, the latch 320 may be a deflectable latch. For example, the latch 320 may be cantilevered from the actuator 310 and is configured to flex when utilized. The latch 320 extends to a distal end 322 and includes a tip 324 at the distal end 322. In an exemplary embodiment, the tip 324 of the latch 320 engages a stop 213 extending from the handle 210. The stop 213 may be located in the pocket 211. The stop 213 holds the header position assurance device 300 in the unlocked position. For example, the latch 320 bottoms out against the stop 213 and the stop 213 prevents actuation and sliding movement of the header position assurance device 300 from the unlocked position to the locked position. When the latch 320 is released from the stop 213 is the header position assurance device 300 able to actuate and move to the locked position. In an exemplary embodiment, the housing locking element 170 is used to release the latch 320 from the stop 213. For example, when the locking mechanism 200 is moved to the locked position (FIG. 10), the housing locking element 170 presses the latch 320 outward to a released position. When the latch 320 is in the released position, the header position assurance device 300 is allowed to move from the unlocked position to a locked position. The header position assurance device 300 is configured to be lockingly secured to the housing locking element 170 in the locked position. In an exemplary embodiment, the header position assurance device 300 includes a locking element 330 having a pocket 332. The locking finger 172 is received in the pocket 332 when the header position assurance device 300 is moved to the locked position to lockingly secure the header position assurance device 300 to the housing locking element 170. The locking finger 172 holds the locking mechanism 200 in the locked position by preventing movement of the locking mechanism 200 away from the header housing 120 in an unlocking direction. Other types of locking features may be used in alternative embodiments.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical connector comprising:
a housing extending between a mating end and a mounting end, the mating end configured to be mated with a mating electrical connector, the mounting end configured to be mounted to a panel, the mounting end including a base and a flange extending from the base, the base of the housing being received in an opening in the panel, the flange of the housing being mounted to a first side of the panel, the housing having a cavity;
a contact assembly received in the cavity of the housing, the contact assembly including at least one contact configured to be mated to the mating electrical connector;
a securing element extending from the housing and located at a second side of the panel; and
a locking mechanism coupled to the securing element, the locking mechanism including a slide configured to interface with the second side of the panel to secure the housing to the panel and move in a sliding locking direction parallel to the second side from an unlocked position to a locked position, the locking mechanism interfacing with the securing element in the locked position to secure the housing to the panel.

2. The electrical connector of claim 1, wherein the housing includes a housing locking element, the locking mechanism including a header position assurance device coupled to the slide, the header position assurance device configured to be lockingly secured to the housing locking element only when the locking mechanism is in the locked position.

3. The electrical connector of claim 2, wherein the header position assurance device is slidably coupled to the locking mechanism and movable between an unlocked position and a locked position, the header position assurance device lockingly securing the locking mechanism to the housing when the header position assurance device is in the locked position.

4. The electrical connector of claim 2, wherein the header position assurance device includes an actuator and a latch extending from the actuator, the latch engaging a stop to hold the header position assurance device in an unlocked position, the housing locking element releasing the latch from the stop when the locking mechanism is in the locked position allowing the header position assurance device to move from the unlocked position to a locked position, the header position assurance device lockingly secured to the housing locking element in the locked position.

5. The electrical connector of claim 2, wherein the housing locking element includes a locking finger, the header position assurance device including a locking element having a pocket, the locking finger received in the pocket to lockingly secure the header position assurance device to the housing locking element.

6. The electrical connector of claim 1, wherein the base of the housing includes a locking leg having a housing locking tab, the locking leg located at the second side of the panel, the locking mechanism including a slide locking tab extending from the slide, the slide locking tab engaging the housing locking tab when the slide is in the locked position to prevent liftoff of the flange of the housing from the first side of the panel.

7. The electrical connector of claim 6, wherein the locking leg and the housing locking tab form a pocket, the slide locking tab received in the pocket when the locking mechanism is in the locked position.

8. The electrical connector of claim 6, wherein the slide locking tab is located between the second side of the panel and the housing locking tab, the slide locking tab preventing movement of the housing locking tab toward the second side of the panel.

9. The electrical connector of claim 1, wherein the slide includes a ramp engaging the securing element as the slide is moved from the unlocked position to the locked position, the ramp forcing the housing to move in a securing direction perpendicular to the sliding locking direction.

10. The electrical connector of claim 1, wherein the slide includes an opening receiving the securing element, the slide positioned between the securing element and the panel to drive the housing in a securing direction perpendicular to the sliding locking direction.

11. The electrical connector of claim 1, wherein the slide includes a handle and a slide arm extending from the handle, the slide arm engaging the securing element to secure the housing to the panel.

12. The electrical connector of claim 1, wherein the securing element includes a shaft and a head, the shaft passing through an opening in the panel, the slide positioned between the head and the panel to lock the housing to the panel.

13. The electrical connector of claim 1, wherein the securing element is a first securing element, the electrical connector further comprising a second securing element, the first and second securing elements being located on opposite sides of the housing, the slide including a first slide arm engaging the first securing element and a second slide arm engaging the second securing element.

14. The electrical connector of claim 1, wherein the slide includes a planar slide interface facing the second side of the panel and sliding along the second side of the panel between the unlocked position and the locked position.

15. The electrical connector of claim 1, further comprising a seal coupled to the flange and surrounding the base, the seal configured to interface with the mounting surface of the panel, the locking mechanism forcing the housing in a securing direction perpendicular to the sliding locking direction to compress the seal as the locking mechanism is moved from the unlocked position to the locked position.

16. The electrical connector of claim 1, wherein the locking mechanism secures the housing to the panel without the use of fasteners.

17. The electrical connector of claim 1, wherein the locking mechanism is slidably coupled to the housing.

18. An electrical connector comprising:
a housing extending between a mating end and a mounting end, the mating end configured to be mated with a mating electrical connector, the mounting end configured to be mounted to a panel, the mounting end including a base and a flange extending from the base, the base of the housing being received in an opening in the panel, the flange of the housing being mounted to a first side of the panel, the housing having a cavity, the housing including a housing locking element;
a contact assembly received in the cavity of the housing, the contact assembly including at least one contact configured to be mated to the mating electrical connector;
a securing element extending from the housing and located at a second side of the panel; and
a locking mechanism coupled to the securing element, the locking mechanism including a slide configured to interface with the second side of the panel to secure the housing to the panel and move in a sliding locking direction parallel to the second side from an unlocked position to a locked position, the locking mechanism interfacing with the securing element in the locked position to secure the housing to the panel, the locking mechanism including a header position assurance device coupled to the slide, the header position assurance device configured to be lockingly secured to the housing locking element only when the locking mechanism is in the locked position.

19. The electrical connector of claim 18, wherein the header position assurance device is slidably coupled to the locking mechanism and movable between an unlocked position and a locked position, the header position assurance device lockingly securing the locking mechanism to the housing when the header position assurance device is in the locked position.

20. The electrical connector of claim 18, wherein the header position assurance device includes an actuator and a latch extending from the actuator, the latch engaging a stop to hold the header position assurance device in an unlocked position, the housing locking element releasing the latch from the stop when the locking mechanism is in the locked position allowing the header position assurance device to move from the unlocked position to a locked position, the header position assurance device lockingly secured to the housing locking element in the locked position.

21. The electrical connector of claim 18, wherein the housing locking element includes a locking finger, the header position assurance device including a locking element having a pocket, the locking finger received in the pocket to lockingly secure the header position assurance device to the housing locking element.

22. An electrical connector comprising:
a housing extending between a mating end and a mounting end, the mating end configured to be mated with a mating electrical connector, the mounting end configured to be mounted to a panel, the mounting end including a base and a flange extending from the base, the flange of the housing being mounted to a first side of the panel, the base of the housing being received in an opening in the panel, the base including a locking leg having a housing locking tab, the locking leg located at a second side of the panel, the housing having a cavity;
a contact assembly received in the cavity of the housing, the contact assembly including at least one contact configured to be mated to the mating electrical connector;
a securing element extending from the housing and located at a second side of the panel; and
a locking mechanism coupled to the securing element, the locking mechanism including a slide configured to interface with the second side of the panel to secure the housing to the panel and move in a sliding locking direction parallel to the second side from an unlocked position to a locked position, the locking mechanism interfacing with the securing element in the locked position to secure the housing to the panel, the locking mechanism including a slide locking tab extending from the slide, the slide locking tab engaging the housing locking tab when the slide is in the locked position to prevent lift off of the flange of the housing from the panel.

23. The electrical connector of claim 22, wherein the locking leg and the housing locking tab form a pocket, the slide locking tab received in the pocket when the locking mechanism is in the locked position.

24. The electrical connector of claim 22, wherein the slide locking tab is located between the second side of the panel in the housing locking tab, the slide locking tab preventing movement of the housing locking tab toward the second side of the panel.
